(19) United States
(12) Patent Application Publication
(10) Pub. No.: US 2015/0112795 A1
(43) Pub. Date: Apr. 23, 2015

(54) EFFICIENT BUDGET PACING

(71) Applicant: Turn Inc., Redwood City, CA (US)

(72) Inventors: Ali Jalali, San Mateo, CA (US); Ali Dasdan, San Jose, CA (US); Kuang-Chih Lee, Union City, CA (US)

(73) Assignee: Turn Inc., Redwood City, CA (US)

(21) Appl. No.: 14/060,862

(22) Filed: Oct. 23, 2013

(51) Int. Cl. G06Q 30/02

(52) U.S. Cl. CPC G06Q 30/0249; G06Q 30/0275
USPC 705/14.48

(57) ABSTRACT

Techniques and mechanisms described herein facilitate efficient budget pacing. According to various embodiments, a plurality of advertising request opportunities may be received at a communications interface during a time interval divided into a plurality of time periods. The time periods may include a designated time period, and a pacing rate for the designated time period may be determined. Each of the advertising request opportunities may be capable of being purchased to present a respective online advertisement. The pacing rate may designate a portion of the advertising request opportunities received during the designated time period on which to bid. One or more instructions may be transmitted to place a plurality of bids on selected ones of the advertising request opportunities received during the designated time period in accordance with the pacing rate.

### TECHNICAL FIELD

The present disclosure relates generally to efficient resource utilization and more specifically to the efficient pacing of budgets for online advertising campaigns.

### DESCRIPTION OF RELATED ART

In online advertising, internet users are presented with advertisements as they browse the internet using a web browser. Online advertising is an efficient way for advertisers to convey advertising information to potential purchasers of goods and services. It is also an efficient tool for non-profit/political organizations to increase the awareness in a target group of people. The presentation of an advertisement to a single internet user is referred to as an ad impression.

Billions of display ad impressions are purchased on a daily basis through public auctions hosted by real time bidding (RTB) exchanges. In many instances, a decision by an advertiser regarding whether to submit a bid for a selected RTB ad request is made in milliseconds. Advertisers often try to buy a set of ad impressions to reach as many targeted users as possible given one or more budget restrictions. Advertisers may seek an advertiser-specific action from advertisement viewers. For instance, an advertiser may seek to have an advertisement viewer purchase a product, fill out a form, sign up for e-mails, and/or perform some other type of action. An action desired by the advertiser may also be referred to as a conversion.

Advertisers often prefer to spend their budget smoothly over the time in order to reach a wider range of audience accessible throughout a day and have a sustainable impact. However, the conversions may occur relatively rarely and the occurrence feedback may be delayed. Thus, a tradeoff exists between achieving budget and performance goals.

### SUMMARY

The following presents a simplified summary of the disclosure in order to provide a basic understanding of certain embodiments of the invention. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

In general, certain embodiments of the present invention provide mechanisms for efficient budget pacing. According to various embodiments, a plurality of advertising request opportunities may be received at a communications interface during a time interval. The time interval may be divided into a plurality of time periods. The plurality of time periods may include a designated time period. Each of the advertising request opportunities may be capable of being purchased to present a respective online advertisement. A pacing rate for the designated time period may be determined. The pacing rate may designate a portion of the advertising request opportunities received during the designated time period on which to bid. One or more instructions may be transmitted to place a plurality of bids on selected ones of the advertising request opportunities received during the designated time period in accordance with the pacing rate. In particular embodiments, each of the advertising request opportunities may be capable of being purchased via an auction mechanism.

In some embodiments, a target budget for the designated time period may be determined. The pacing rate for the designated time period may be determined based on the target budget for the designated time period. The target budget may be determined at least in part by identifying an aggregate budget and an allocated budget expenditure. The aggregate budget may identify a first amount for spending during the time interval. The allocated budget expenditure may identify a second amount for spending during the designated time period. The target budget for the designated time period may depend on the first and second amounts.

In some implementations, the target budget may be determined at least in part by identifying a first length of time associated with the time interval and a second length of time associated with the designated time period. The target budget for the designated time period may depend on the first and second lengths of time.

In some embodiments, the pacing rate for the designated time period may be determined in accordance with a uniform pacing strategy that is configured to provide an approximately uniform budget distribution across the plurality of time periods.

In some embodiments, the pacing rate for the designated time period may be determined in accordance with a weighted pacing strategy that is configured to allocate relatively larger budget amounts to time periods during which received advertising request opportunities are expected to be associated with a relatively higher probability of success. The probability of success may be the probability of a click or the probability of a conversion.

In some embodiments, the target budget may be determined at least in part by identifying a plurality of success probabilities. Each success probability may be associated with a respective one of the plurality of time periods and may indicate a relative quality of advertising request opportunities received during the respective time period. The target budget for the designated time period may depend on the plurality of success probabilities.

In some embodiments, the pacing rate for the designated time period comprises may be determined at least in part by estimating a win ratio for the designated time period. The estimated win ratio may indicate a ratio of a first win rate for the designated time period and a second win rate for a preceding time period. The win rate for a time period may indicate a probability that a bid placed on an advertising request opportunity received during the time period is successful.

In some embodiments, the pacing rate for the designated time period comprises may be determined at least in part by estimating a request ratio for the designated time period. The estimated request ratio may indicate a ratio of a first number of advertising request opportunities received during the designated time period and a second number of advertising request opportunities received during a preceding time period.

### BRIEF DESCRIPTION OF THE DRAWINGS

The disclosure may best be understood by reference to the following description taken in conjunction with the accompanying drawings, which illustrate particular embodiments of the present invention.

FIGS. 1A-E illustrates graphs of budget pacing schemes, presented in accordance with one or more embodiments.

FIG. 2 illustrates an example of a budget pacing determination method, performed in accordance with one or more embodiments.

FIG. 3 illustrates an example of a target budget determination method, performed in accordance with one or more embodiments.

FIG. 4 illustrates an example of a server, configured in accordance with one or more embodiments.

### DESCRIPTION OF PARTICULAR EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques and mechanisms of the present invention will be described in the context of particular techniques and mechanisms related to advertising campaigns. However, it should be noted that the techniques and mechanisms of the present invention apply to a variety of different computing techniques and mechanisms. In the following description, numerous specific details are set forth in order to provide a thorough understanding of the present invention. Particular example embodiments of the present invention may be implemented without some or all of these specific details. In other instances, well known process operations have not been described in detail so as not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

According to various embodiments, techniques and mechanisms described herein facilitate efficient budget pacing, which refers to the rate at which a budget is spent over time. When executing an online advertising campaign, an advertiser or an agent of an advertiser spends an advertising budget by bidding on advertising requests provided by a real time bidding (RTB) exchange. The advertiser may prefer that the budget be used to purchase high quality impressions. At the same time, the advertiser may prefer that the budget be spent relatively smoothly over a period of time. Techniques described herein may facilitate smooth budget delivery combined with high conversion performance for an online advertising campaign. High quality impressions may be selected from a pool of available advertising impressions. The bid price may be adjusted in an adaptive manner to distribute the budget across time. For instance, the bid price may be adjusted based on factors such as the prior performance distribution.

### Example Embodiments

In recent years, the amount of ad impressions sold through real time bidding (RTB) exchanges has experienced a tremendous growth. RTB exchanges provide a technology for advertisers to algorithmically place a bid on any individual impression through a public auction. This functionality allows advertisers to buy inventory in a cost effective manner and to serve ads to the right person in the right context at the right time. However, in order to realize such functionality, advertisers need to intelligently evaluate each impression in real time or near real time. Demand-side platforms (DSPs) provide real time bid optimization techniques to help advertisers determine a bid value for each ad request very quickly. For instance, a DSP may determine a bid value in milliseconds for close to a million bids per second.

In order to use the services of a DSP, an advertiser may specify one or more parameters for an advertising campaign. The advertising campaign may include features such as a target audience and one or more budget restrictions. A budget restriction may designate an amount of money that the DSP may and/or should spend on the purchase of advertising impressions during the execution of the advertising campaign. For instance, an advertising campaign may be associated with a daily budget, a weekly budget, or any other type of budget restriction.

In order to meet budget restrictions associated with an advertising campaign, a DSP may take a budget as input and calculate a serving schedule for the campaign. Based on the serving schedule, the ad serving system can attempt to spread out impressions served for a campaign to avoid spending the budget all at once. For instance, the system may attempt to spend a daily budget for a campaign uniformly over the course of a day. However, such a strategy ignores differences in internet traffic and advertising impression performance metrics. For instance, the traffic profile distribution and past performance metrics may be such that advertising impressions during one part of the day may be more valuable than advertising impressions during another part of the day.

According to various embodiments, techniques and mechanisms described herein facilitate smooth budget pacing that takes into account various types of performance and delivery information. A real time bid optimization procedure attempts to meet or maximize one or more campaign performance goals under one or more delivery constraints within the budget schedule.

According to various embodiments, a performance goal can be specified by designating a performance metric such as cost-per-click (CPC), cost-per-action (CPA), click-through-rate (CTR), or action-rate (AR). In general, a lower CPC or CPA is more desirable, while a higher CTR or AR is more desirable. A performance goal may include a target level for a metric or may indicate that the metric is to be maximized or minimized, whichever is appropriate.

According to various embodiments, a smooth budget delivery constraint may be used to prevent the campaign from finishing the budget prematurely or avoiding a bursty spending rate. For instance, a smooth budget delivery constraint may be expressed as not buying more than a set fraction of the impressions of interest before a set time. Such a constraint may help advertisers to have sustainable influence with their ads, to avoid pushing large amount of ads in peak traffic (while performance may be degraded), and/or to explore a broader range of audience.

Performance of real time bid optimization in a RTB environment can be challenging for any or all of various reasons. For example, click and conversion events can be very rare for non-search advertisement. Therefore, the variance when estimating past performance metrics can be large.

As another example, the decision as to whether to place a bid and how to evaluate the bid price may need to be performed for an individual ad request very quickly, for instance in only a few milliseconds. At the same time, some DSPs typically receive as many as a million ad requests per second while hundreds of millions of users simultaneously explore the web around the globe. The short latency and high throughput requirements can introduce extreme time sensitivity into the process.

As yet another example, much information can be missing when individual ad requests are evaluated in real time or near real time. For instance, the feedback on previous decisions may have a long delay in practice. The collection of click information can be delayed because of the duplication removal during the logging process. At the same time, many view-through actions can take up to seven days to be converted and attributed to the corresponding impressions.

According to various embodiments, techniques and mechanisms described herein provide an online approach to enhancing performance metrics for an advertising campaign while satisfying budget constraints such as a smooth delivery constraint and/or a budget limit for the campaign. A control feedback loop may be applied to iteratively estimate the future spending rate in order to impose smooth delivery constraints. The spending rate may be used to select high quality impressions and adjust the bid price based on the prior performance distribution to maximize the performance goal.

In some implementations, techniques and mechanisms may be described herein as solving “optimization” problems or as “optimizing” one or more parameters. It should be noted that the term optimize does not imply that the solution determined or parameter selected is necessarily the best according to any particular metric. For instance, some optimization problems are computationally intense, and computing the best solution may be impractical. Accordingly, optimization may involve the selection of a suitable parameter value or a suitably accurate solution. In some instances, the suitability of a parameter value or solution may be strategically determined based on various factors such as one or more computing capabilities, problem characteristics, and/or time constraints.

According to various embodiments, techniques and mechanisms may be described herein as distributing a daily budget for an advertising campaign over the course of a day. However, it should be noted that different advertising campaigns may have different types of budgets and/or budget constraints. For instance, the budgets for some advertising campaigns may be allocated and smoothed over the course of an hour, a week, a year, or some other time period to meet the needs of an advertiser.

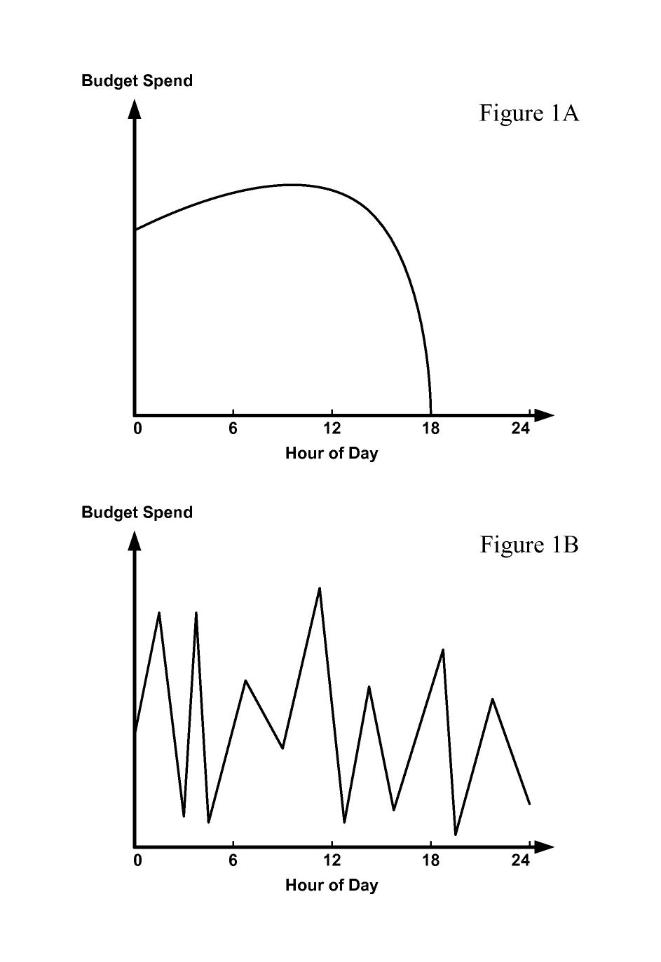

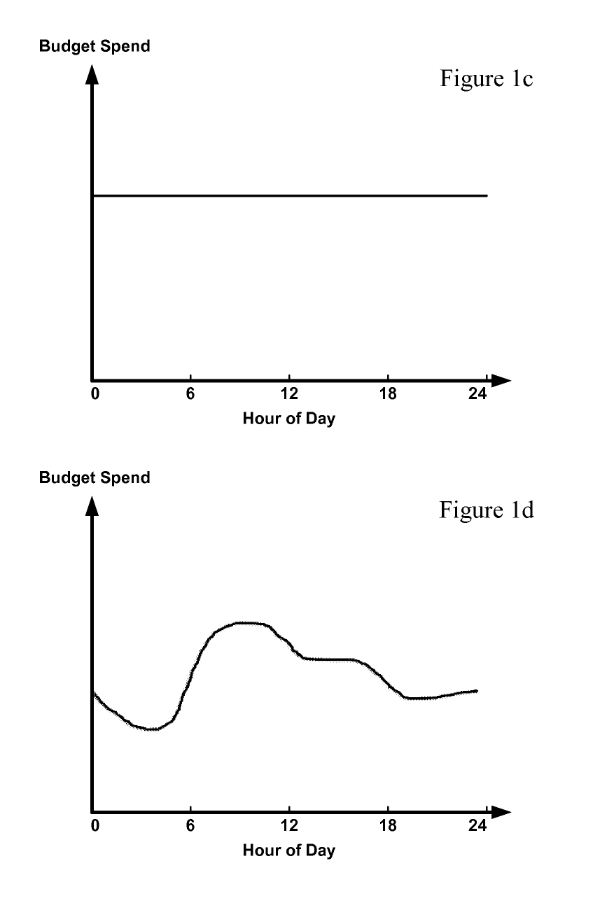

FIGS. 1A-E illustrates graphs of budget pacing schemes, presented in accordance with one or more embodiments. One example of a setting in which the budget pacing schemes illustrated in FIGS. 1A-E may occur is as follows. Suppose that a series of ad requests arrive sequentially. An advertiser would like to make a decision regarding whether to bid on each of the ad requests. The advertiser may specify a budget constraint such as a total daily budget to be spent on ad requests. In many advertising campaigns, advertisers would also like to impose a smooth budget delivery constraint to avoid situations such as a premature campaign stop or a fluctuating expenditure.

FIG. 1A illustrates an example of a premature campaign stop. In FIG. 1A, the entire daily budget of the advertising campaign is spent by hour 18. In this situation, the advertiser associated with the campaign has missed any opportunities that occur after hour 18 since no budget remains in the campaign for bidding on those advertising impressions. Accordingly, many advertisers would prefer to avoid a budget pacing scheme similar to that shown in FIG. 1A.

FIG. 1B illustrates an example of fluctuation in spend. Many advertisers prefer to avoid fluctuating spend for various reasons. For instance, many advertisers would like to be able to analyze their campaigns regularly, but high fluctuations in the budget may decrease the consistency of analysis results. Accordingly, many advertisers would prefer to avoid a budget pacing scheme similar to that shown in FIG. 1B.

FIG. 1C illustrates an example of an advertising campaign with uniform budget pacing. In this scheme the budget is uniformly split across the day. However, a uniform budget pacing scheme may impose one or more drawbacks. Accordingly, many advertisers would prefer to avoid a budget pacing scheme similar to that shown in FIG. 1C.

One potential drawback of a uniform budget pacing scheme is that, depending on the audience targeted by an advertising campaign, the volume of the online traffic can vary significantly throughout the day. For instance, it might be the case that traffic received during the first half of the day is more relevant than traffic received during the second half of the day. However, uniform budget pacing scheme ignores this difference in traffic relevance. In such a situation, some of the allotted budget may not be spent by the end of the day, or the budget may be spent on relatively low quality ad impressions in the second half of the day.

Another potential drawback of a uniform budget pacing scheme is that, the quality of the online traffic can change over the course of the day for different groups of an audience. Whether quality is being measured by CPC, CPA, CTR or AR, an advertiser may prefer that the budget be allocated primarily to time periods of the day with high quality. Due to these and other potential drawbacks associated with uniform budget pacing, a uniform budget pacing scheme may not meet the needs of at least some advertisers.

FIG. 1D illustrates an example of an advertising campaign with uniform budget pacing with respect to the traffic. In some instances, uniform budget pacing with respect to traffic may address some of the issues with uniform budget pacing with respect to time in terms of variation of traffic throughout the day. However, uniform budget pacing with respect to traffic may still ignore changes to the quality of the online traffic over the course of the day.

FIG. 1E illustrates an example of an advertising campaign with a budget pacing scheme that has a uniform baseline with additional budget portions allocated based on traffic quality. However, such a scheme may have large fluctuations that may violate smooth delivery constraints. As well, such a scheme may ignore changes in traffic volume over the course of the day.

In order to enforce the smooth delivery constraints, the overall daily budget B can be broken down into a sequence of time slot schedules {b₁, . . . , b_{T}}, where bₜ represents the budget that is allocated for advertising impressions available during time slot t. Since the entire budget is allocated for spending, the sum of the budgets allocated to the different time slots may be approximately or exactly equal to the overall budget for the day. According to various embodiments, various pacing strategies may be used to assign the bₜ values to select high quality impressions while adhering to one or more budget pacing conditions.

In some embodiments, each ad request i may fall within one of the time slot schedules. Each ad request xᵢ may be associated with a value vᵢ and a cost cᵢ. For instance, the value may be treated as representing the value for the advertiser if the given ad request is viewed by an audience member. The cost may be treated as representing the actual cost to the advertiser for the ad request, which is paid to the publisher who serves the corresponding impression.

In some implementations, the DSP may attempt to maximize the total value to the advertiser subject to the budget constraint. Accordingly, the DSP may attempt to solve the following maximization problem:

$$maximize {\sum }_{i = 1}^{n} {v}_{i} {x}_{i}$$

$$subject to {\sum }_{j ∈ {I}_{t}} {c}_{j} {x}_{j} \leq {b}_{t} ∀ t ∈ \{ 1 , … , T \}$$

In the preceding maximization problem, Iₜ represents the index set of all advertising requests that are received in the time slot t.

According to various embodiments, the maximization problem described in the immediately preceding paragraphs may be conceptualized as a theoretical or offline maximization problem since the cost and value of future ad requests may be unclear when decisions regarding budget pacing are made for a particular time period. That is, when an incoming ad request is received, a decision may need to be made regarding whether to bid on the ad request without observing data regarding future ad requests.

In particular embodiments, when bid values are determined dynamically, an estimated cost for the ad impression may need to be determined. In many RTB exchanges, the actual cost of an ad impression may be determined by an auction mechanism such as a second price auction. In such situations, a bid that is slightly higher than the estimated cost of the ad impression may need to be placed in order to win the second price auction and pay the estimated cost. The actual value of the bid placed for a given ad impression may be strategically determined based on one or more of various factors such as the characteristics of the auction employed by the RTB and the estimated cost of the ad impression.

Various approaches to solving optimization problems of the types described herein may suffer from one or more drawbacks. For example, some approaches to solving optimization problems model the budget constrained bidding optimization problem as an online knapsack problem (e.g., which is analogous to determining what packages are within a closed knapsack based on known weights of individual packages and filled knapsack). When employing such approaches, high quality ad requests may be selected based on an exponential function with respect to the budget period. As time goes by, increasingly higher quality ad requests can be selected. However, these types of approaches may rely on an underlying assumption of unlimited supply of future ad requests in the RTB environment. Such an assumption is impractical in many advertising campaigns, such as those campaigns with strict audience targeting constraints.

As another example, the problem of dynamic bidding price may be formulated using a multi-armed bandit framework (e.g., which is analogous to a gambler facing a set of slot machines or “one-armed bandits” and determining which slot machines to play, how many times to play each slot machine, and in which order to play the slot machines). Then, the strategy of upper confidence bound may be applied to explore the optimal price of online transactions. However, multi-armed bandit frameworks typically need to collect feedback quickly from the environment in order to update the utility function. The collection of bidding and performance information often involves a longer delay for display advertising in an RTB environment, thus rendering this approach impractical in many situations.

As yet another example, a general online linear programming algorithm may be used. A standard linear programming solver may be used to compute the optimal dual solution for the data which have been seen in the system. Then, the solution for the new instance can be decided by checking if the dual solution with the new instance satisfies the constraint. However, the true value and cost parameters for an incoming ad request may be unknown when the ad request arrives at the system. If these parameters are estimated, then the dual solution may need to be re-computed more frequently for each campaign in order to impose budget constraints accurately. This frequent re-computation may introduce high computational cost in the real time bidding system.

According to various embodiments, advertising campaigns may be divided into at least two categories. One category includes flat CPM campaigns, in which the same bid price is submitted whenever a decision is made to bid on an advertising request. Another category includes dynamic CPM campaigns, in which the bid price is dynamically determined. In both types of campaigns, a determination is made as to whether to bid on an advertising request.

In some embodiments, different metrics may be used to evaluate decisions made in different types of campaigns. For instance, the success of decisions made in a flat CPM campaign may often be based on a metric such as CTR or AR. In contrast, the success of decisions made in a dynamic CPM campaign may be based on a metric such as effective CPC (eCPC) or effective CPA (eCPA). The eCPC may be the cost-per-click that is actually realized, while the CPC may be the desired cost-per-click. Similarly, the eCPA may be the cost-per-action that is actually realized, while the CPA may be the desired cost-per-action.

According to various embodiments, the following optimization problem illustrates the type of calculation that may be performed in order to determine whether to bid on an ad request and, if in a dynamic CPM campaign, what bid to place on the ad request.

$$minimize \text{-} CTR , \text{-} AR , eCPC , or eCPA$$

$$such that \vert {\sum }_{t}^{T} s ( t ) - B \vert \leq ε$$

$$\vert s ( t ) - {b}_{t} \vert \leq {δ}_{t} ∀ t ∈ \{ 1 , … , T \}$$

$$eCPM \leq M$$

According to various embodiments, the first constraint in the preceding optimization problem may be treated as the total daily budget constraint, where s(t) represents the budget spent during time slot t, and ε represents an upper bound on the underspend or overspend total. The second constraint may be treated as enforcing smooth budget delivery according to the schedule bₜ, where δₜ represents an upper bound on the underspend or overspend for time slot t. The third constraint may be treated as requiring that eCPM does not exceed the cap M. This constraint may help make a dynamic CPM campaign to appear more like a CPM campaign on average over time.

According to various embodiments, the preceding optimization problem may be used to select the parameter bₜ. For instance, the total budget B and the average impression cost cap M may be set for a campaign by the advertiser.

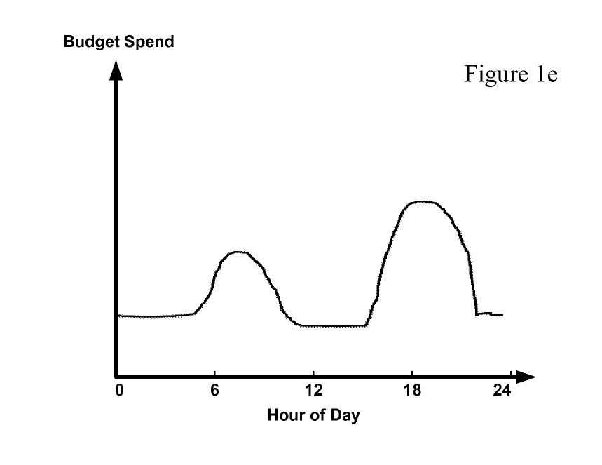

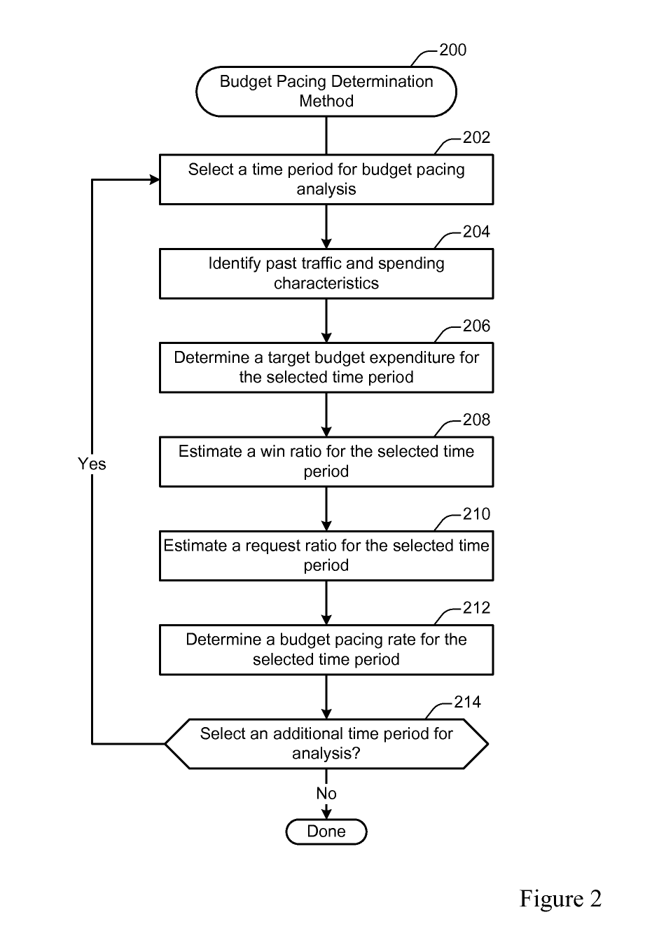

FIG. 2 illustrates an example of a budget pacing determination method 200, performed in accordance with one or more embodiments. The method 200 may be used to calculate a delivery schedule in real-time or near real-time for an advertising campaign. For example, the delivery schedule may be used to spread out the actions of acquiring impressions for a campaign throughout the day. For instance, a day can be broken down into T time periods. In each time period, a target budget can be assigned for spending in association with the each campaign.

Since advertising requests may be purchased via an auction mechanism, the actual budget spent for a time period may differ somewhat from the target budget for the time period. For instance, the actual amount spent during a time period may be determined by factors such as the bid amount for the time period, the win rate for the time period, and the number of requests bid upon during the time period.

In some embodiments, the delivery schedule may designate a per-period pacing rate for a time period in order to spend approximately the target budget for the time period. The pacing rate may designate the portion of incoming ad requests that are bid on for the campaign during the time period. For instance, the pacing rate may indicate that 15% of the incoming ad requests during the time period are to be bid on for the advertising campaign.

At 202, a time period for budget pacing analysis is selected. According to various embodiments, decisions regarding budget pacing may be made in real-time or near real-time. Accordingly, the time period selected for analysis may be the next time period in which advertising requests are received. Initially, the first time period may be selected.

According to various embodiments, a day may be divided into various numbers of time periods. For instance, a day may be divided into time periods of ten seconds, one minute, five minutes, or any suitable length of time. In some campaigns, all time periods for a campaign may be assigned to have equal length. Alternately, in some campaigns, different time periods may have different lengths.

In some embodiments, the amount of money spent during a given time period is considered to be proportional to the number of impressions served at that time period. This amount of money spent during a time period may be referred to as the “spend” of acquiring inventory for the time period. In general, the price of individual impressions for a particular campaign may remain approximately constant during a given time period. For instance, the length of the time period may be chosen such that the variance of individual impression price for each campaign is small.

At 204, past traffic and spending characteristics are identified. According to various embodiments, various types of information associated with previous time periods may be used to facilitate the determination of a pacing rate for the time period being analyzed. The past traffic and spending characteristics may include, but are not limited to, the actual spend for one or more previous periods, the pacing rate for one or more previous periods, the win rate for one or more previous periods, the number of requests for one or more previous periods, and various historical data.

In some embodiments, past traffic and spending characteristics may be stored in a storage system for the purpose of traffic analysis. For instance, when a time period is completed, information regarding the advertising requests received, the bids placed, the budget spent, and other such characteristics may be stored. Some or all of this information may then be retrieved for analysis during subsequent time periods.

In some embodiments, the actual spend for a previous time period may indicate that actual amount of budget that was spent on advertising requests for the previous time period. The actual amount spent may depend on factors such as the bid amount for the previous time period, the number of bids bid upon during the previous time period, and the percentage of successful bids during the previous time period.

In some embodiments, the win rate for a previous time period may identify the percentage or proportion of bids placed during the previous time period that were successful. For instance, if bids were placed on 5,000 adverting requests during the previous time period and the advertising campaign was successful in purchasing 1,000 of those requests, then the win rate for the previous time period would be 20%.

In some embodiments, the number of requests for a previous time period may identify the number of advertising requests for the previous time period on which it would have been possible to place a bid. In some instances, the number of requests may be defined as the number of available advertising requests that fall within one or more constraints or conditions specified by the advertising campaign. For instance, the advertising campaign may target one or more specific audiences or exclude one or more specific audiences.

In some embodiments, historical data from one or more previous time periods may be identified. Historical data may be used to make predictions regarding the time period selected for analysis. For example, historical data may indicate information such as a number of requests received during a previous time periods in the same day and/or a number of requests received during a previous time period in a previous day. As another example, historical data may indicate information such as a win rate during a previous time periods in the same day and/or a win rate during a previous time period in a previous day.

At 206, a target budget expenditure is determined for the selected time period. According to various embodiments, various techniques may be used to determine the target budget spend. For example, in a uniform budget pacing approach, the budget may be spent approximately evenly over the course of a day. As another example, relatively higher budget amounts may be allocated to time slots where a campaign has a greater chance to spend the budget on higher quality ad impressions. A higher quality ad impression may be one that has an increased probability of triggering an event of interest such as a click or conversion.

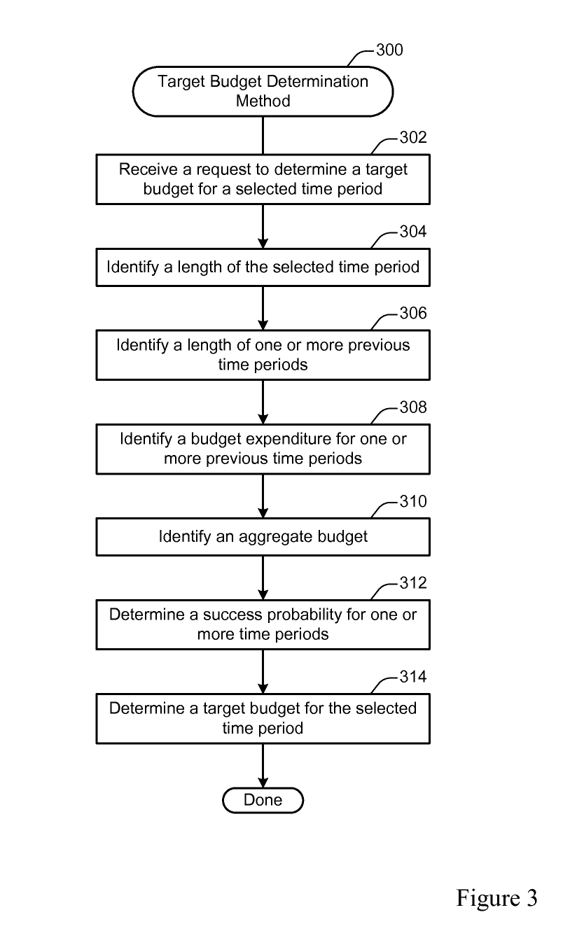

According to various embodiments, any of various types of budget distributions may be applied to an advertising campaign by selecting an appropriate target budget for each time period. For example, an approximately uniform pacing strategy may be implemented by adjusting the ideal budget expenditure to be approximately even over the course of the day. As another example, the target budget may be selected to weight certain periods of the day more highly. FIG. 3 describes examples of methods that may be used to determine a target budget for a time period according to different budget pacing strategies.

At 208, a win ratio for the selected time period is estimated. According to various embodiments, the estimated win ratio for the selected time period may identify an estimated ratio of win rates for different time periods. For instance, the estimated win ratio for the selected time period may identify an estimated ratio of the win rate for the immediately preceding time period and the estimated win rate for the selected time period.

In some embodiments, the win ratio for the selected time period may be estimated by combining information describing actual win ratios. For instance, the actual win ratio for the selected time period and the immediately preceding time period may be combined with historical information such as actual win ratios for time periods during previous, hours, days, or weeks.

At 210, a request ratio for the selected time period is estimated. According to various embodiments, the estimated request ratio for the selected time period may identify an estimated ratio of numbers of requests received during different time periods. For instance, the estimated request ratio for the selected time period may identify an estimated ratio of the number of requests received during the immediately preceding time period and the estimated number of requests to be received during the selected time period.

In some embodiments, the request ratio for the selected time period may be estimated by combining information describing actual numbers of requests. For instance, the actual number of requests for the selected time period and the immediately preceding time period may be combined with historical information such as actual numbers of requests for time periods during previous, hours, days, or weeks.

At 212, a budget pacing rate is determined for the selected time period. According to various embodiments, the budget pacing rate may identify the proportion of incoming ad requests received during the selected time period on which to bid. The budget pacing rate may be determined based on any of various factors which may include, but are not limited to: the estimated win ratio for the selected time period, the estimated request ratio for the selected time period, the target budget expenditure for the selected time period, and the budget expenditure for the immediately preceding time period.

In some embodiments, the budget pacing rate may be determined by calculating the result of a formula such as the following formula:

$$pacing\_rate ( t ) = \frac{target\_budget ( t )}{budget\_spent ( t - 1 )} * request\_ratio ( t ) * win\_ratio ( t )$$

In some embodiments, the formula may be written as follows:

$$pacing\_rate ( t ) = \frac{target\_budget ( t )}{budget\_spent ( t - 1 )} * \frac{requests ( t - 1 )}{requests ( t )} * \frac{win\_rate ( t - 1 )}{win\_rate ( t )}$$

In some embodiments, determining the budget pacing rate may involve storing the budget pacing rate on a storage system or in memory. The budget pacing rate may then be used to identify incoming ad requests on which to bid. For instance, if the budget pacing rate is 10%, then 10% of the incoming ad requests received during the selected time period that meet the criteria of the advertising campaign may be bid upon.

In particular embodiments, a pacing rate may be saved to local storage, for instance in a control server, when the pacing rate is updated. If the service is restarted, the pacing module may attempt to re-load all previous pacing information to avoid resetting the pacing rate to the initial values.

In particular embodiments, a pacing rate may be decreased below the rate that would otherwise be used as the day or other longer time interval draws to a close in order to prevent overspending. In some instances, a module may periodically determine whether the current aggregate spend is less than the daily cap and the cap for the selected time interval.

In particular embodiments, different pacing strategies may be executed for different types of advertising requests. Alternately, or additionally, pacing strategies may be changed by altering the techniques used to compute the pacing rate. For instance, one formula used to compute a pacing rate may be substituted for a different pacing rate formula.

At 214, a determination is made as to whether to select an additional time period for analysis. As discussed with respect to operation 202, decisions regarding budget pacing may be made in real-time or near real-time. Accordingly, the time period selected for analysis may be the next time period in which advertising requests are received. When a time period has passed, the next time period may be selected. For instance, time periods may continue to be selected until the advertising campaign or the day is completed.

FIG. 3 illustrates an example of a target budget determination method 300, performed in accordance with one or more embodiments. According to various embodiments, the method 300 may be performed in succession for a number of time periods in order to distribute a budget approximately uniformly over the time periods. For instance, the method 300 may be performed for each time period within a day in order to distribute the budget for the day uniformly over the day.

At 302, a request to determine a target budget for a selected time period is received. According to various embodiments, the request may be received as part of a procedure for determining a pacing rate for the selected time period, as discussed with respect to FIG. 2. For instance, the request may be generated in conjunction with the operation 206 described with respect to FIG. 2.

At 304, a length of the selected time period is identified. According to various embodiments, the length of the selected time period may indicate the amount of time during which operations associated with the selected time period take place. For instance, the target budget may be determined for use during the selected time period. The target budget for the time period may then be applied to ad requests received during the selected time period.

According to various embodiments, the length of time and other parameters may be determined by retrieving them from memory or a storage system. For instance, the system may store information such as the length of time of each time period, the budget expenditure for past time periods, and other parameters. This information may then be retrieved upon request for use in analysis or for other purposes.

At 306, a length of one or more previous time periods is identified. For instance, the length of each time period during the course of the day may be identified. The lengths of previous time periods may be identified individually or in the aggregate. For example, a running total of the length of time associated with all previous time periods during the course of the day may be maintained and updated.

In some implementations, each time period may be assigned the same length. Alternately, different time periods may be assigned different lengths. For instance, some periods of the day may be associated with high volatility in terms of the quantity and quality of advertising requests received and thus may be assigned shorter time periods. Other periods of the day may be associated with low volatility and be assigned longer time periods.

At 308, a budget expenditure for one or more previous time periods is identified. For instance, the budget expenditure of each time period during the course of the day may be identified. The budget expenditures of previous time periods may be identified individually or in the aggregate. For example, a running total of the budget expenditure associated with all previous time periods during the course of the day may be maintained and updated.

At 310, an aggregate budget is identified. According to various embodiments, the aggregate budget may identify a budget amount that is allocated for expenditure over a longer interval of time. The aggregate budget may be identified in order to divide the aggregate budget into allocations for the longer time interval among the different time periods in such a way that the budget constraint for the longer time interval is satisfied. For instance, the aggregate time interval may indicate an amount of money allocated for expenditure over a day, a week, an hour, or some other interval of time.

In some implementations, the aggregate budget may identify a target budget expenditure for the longer time interval. Alternately, or additionally, the aggregate budget may identify a maximum budget for the longer time interval.

At 312, a success probability for one or more time periods is determined. In some implementations, the success probability may be used to incorporate historical information into budget pacing analysis. For instance, an advertising campaign and/or pacing procedure designer may incorporate domain-specific knowledge into budget pacing.

For example, a designer with knowledge or experience in car dealing might believe that advertising during particular hours of the day or days of the week is more successful than advertising during other time periods. Based on this knowledge, the designer may define success probabilities to bias the budget pacing toward these desirable time periods.

As another example, a business owner may choose to restrict advertisement to a time period encompassing the hours of operation of the business. For instance, most advertising may be performed when the business is open, with a gradual increase in advertisement during the time period before the business opens. Suppose, for instance, that the business is a restaurant. The restaurant may prefer to begin presenting advertisements in the hours leading up to lunch time. Then, advertisement may be decreased during the early afternoon and increased again closer to the dinner time.

In some implementations, a success probability for a time period may indicate the probability of a click, conversion, or other successful outcome for the time period. Alternately, a success probability may be associated or correlated with the probability of a successful outcome. A success probability may be calculated exactly or estimated. For instance, a success probability may be determined by analyzing campaign history data or measuring the performance of the campaign during previous time periods.

According to various embodiments, potentially many different success probabilities may be determined. For instance, success probabilities may be combined to produce a discrete probability density function that assigns a success probability for each period during the course of a longer time interval such as a day. When a discrete probability density function is used, the success probabilities over the course of the day may sum to one. In such a model, higher probabilities may be associated with higher success rates but may not indicate the actual estimated success rate for a given time period. In this way, a probability density function may be used to weight the budget allocation among the different time periods based on the relative quality of the ad impressions received in different time periods.

In some implementations, one or more actual success metrics may be calculated exactly, as opposed to success probabilities, based on received success metric information for a given time period. Alternately, or additionally, one or more success probabilities may be estimated for the selected time period and even for periods in the past since information regarding the success of recent advertisements may be unavailable for a period of time.

At 314, a target budget for the selected time period is determined. According to various embodiments, the target budget for the selected time period may be determined by any of various budget pacing strategies. For example, a uniform budget pacing strategy may be applied. As another example, a budget pacing strategy may allocate a larger budget to time periods in which advertising requests have a higher probability of success. For instance, some periods of time may be associated with a higher probability of clicks or conversions for advertising requests.

In some implementations, the target budget may be determined based on a uniform pacing strategy. A uniform pacing strategy may attempt to spend the aggregate budget evenly over the course of the day, even as the number and quality of advertising requests changes. For instance, the target budget bₜ for period t may be calculated based on the following formula. In this formula, B represents the aggregate budget, spend(m) represents the budget expenditure during the time period m, L(t) represents the length of the selected time period t, and L(m) represents the length of the previous time period m.

$${b}_{t} = ( B - {\sum }_{m = 1}^{t - 1} spend ( m ) ) \frac{L ( t )}{{\sum }_{m = t}^{T} L ( m )}$$

In some implementations, each time period during a longer interval such as a day may be assigned an equal length. When such a strategy is implemented, the previous equation may be simplified to the following formula. In the following formula, T represents the total amount of time that is divided into time intervals. For instance, T may represent the amount of time that passes during one day.

$${b}_{t} = ( B - {\sum }_{m = 1}^{t - 1} spend ( m ) ) \frac{1}{T - t}$$

In some implementations, a budget pacing strategy may allocate a larger portion of the budget to time periods in which advertising requests have a higher probability of success. For instance, the target budget bₜ for period t may be calculated based on the following formula. In this formula, pₜ represents the probability of success during period t. As described herein, the probability of success may be defined in various ways based on the strategic objectives of the advertising campaign.

$${b}_{t} = ( B - {\sum }_{m = 1}^{t - 1} spend ( m ) ) \frac{{p}_{t} \cdot L ( t )}{{\sum }_{m = t}^{T} {p}_{m} L ( m )}$$

In some implementations, each time period during a longer interval such as a day may be assigned an equal length. When such a strategy is implemented, the previous equation may be simplified to the following formula. In the following formula, T represents the total amount of time that is divided into time intervals. For instance, T may represent the amount of time that passes during one day.

$${b}_{t} = ( B - {\sum }_{m = 1}^{t - 1} spend ( m ) ) \frac{{p}_{t}}{{\sum }_{m = t}^{T} {p}_{m}}$$

In some implementations, initialization values may be used when calculating formulas described herein, for instance for the first period of the day. For example, initialization values may be set based on the results of time intervals in previous days. As another example, initialization values may be set to designated constant values such as zero values, small non-zero values, or other constant values.

In some implementations, one or more of the operations shown in FIG. 3 may be omitted. Alternately, or additionally, one or more additional operations not shown in FIG. 3 may be performed. For example, when implementing a uniform budget pacing strategy, determining a success probability may be omitted. As another example, other budget pacing strategies may involve information not discussed with respect to FIG. 3. In particular embodiments, the specific information used to determine the target budget may be strategically determined based on the type of budget pacing being performed.

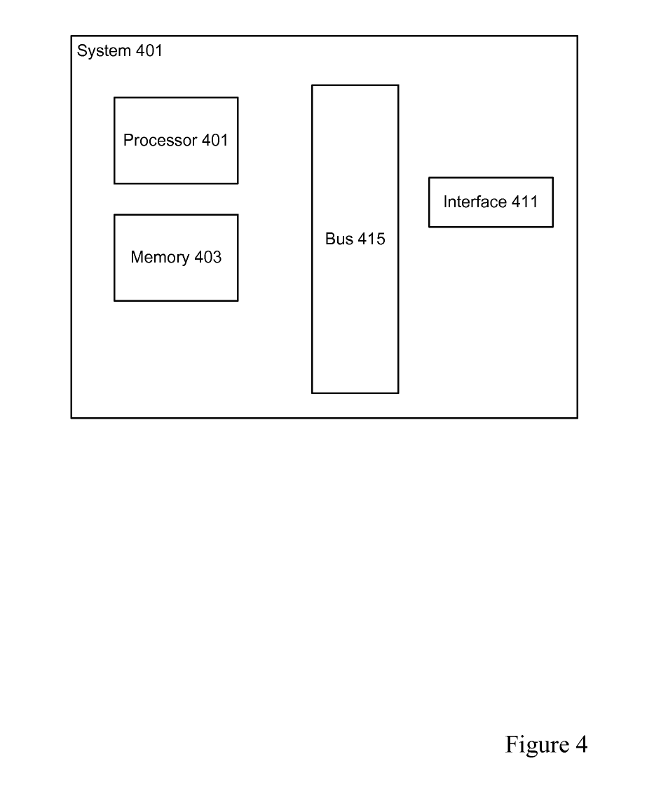

FIG. 4 illustrates one example of a server. According to particular embodiments, a system 400 suitable for implementing particular embodiments of the present invention includes a processor 401, a memory 403, an interface 411, and a bus 415 (e.g., a PCI bus or other interconnection fabric) and operates as a counter node, aggregator node, calling service, zookeeper, or any other device or service described herein. Various specially configured devices can also be used in place of a processor 401 or in addition to processor 401. The interface 411 is typically configured to send and receive data packets over a network.

Particular examples of interfaces supported include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. Although a particular server is described, it should be recognized that a variety of alternative configurations are possible.

Although many of the components and processes are described above in the singular for convenience, it will be appreciated by one of skill in the art that multiple components and repeated processes can also be used to practice the techniques of the present invention.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

What is claimed is:

1. A method comprising:
receiving, at a communications interface, a plurality of advertising request opportunities during a time interval, the time interval divided into a plurality of time periods, the plurality of time periods including a designated time period, each of the advertising request opportunities capable of being purchased to present a respective online advertisement;
determining, via a processor, a pacing rate for the designated time period, the pacing rate designating a portion of the advertising request opportunities received during the designated time period on which to bid; and
transmitting one or more instructions to place a plurality of bids on selected ones of the advertising request opportunities received during the designated time period in accordance with the pacing rate.

2. The method recited in claim 1, the method further comprising:
determining a target budget for the designated time period, wherein the pacing rate for the designated time period is determined based on the target budget for the designated time period.

3. The method recited in claim 2,
wherein determining the target budget comprises identifying an aggregate budget and an allocated budget expenditure, the aggregate budget identifying a first amount for spending during the time interval, the allocated budget expenditure identifying a second amount for spending during the designated time period, the target budget for the designated time period depending on the first amount and the second amount.

4. The method recited in claim 2,
wherein determining the target budget comprises identifying a first length of time associated with the time interval and a second length of time associated with the designated time period, the target budget for the designated time period depending on the first length of time and the second length of time.

5. The method recited in claim 2,
wherein the pacing rate for the designated time period is determined in accordance with a uniform pacing strategy, the uniform pacing strategy configured to provide an approximately uniform budget distribution across the plurality of time periods.

6. The method recited in claim 2,
wherein the pacing rate for the designated time period is determined in accordance with a weighted pacing strategy, the weighted pacing strategy configured to allocate relatively larger budget amounts to time periods during which received advertising request opportunities are expected to be associated with a relatively higher probability of success.

7. The method recited in claim 6,
wherein the probability of success is a probability selected from the group consisting of: the probability of a click and the probability of a conversion.

8. The method recited in claim 6,
wherein determining the target budget comprises identifying a plurality of success probabilities, each success probability being associated with a respective one of the plurality of time periods, each success probability indicating a relative quality of advertising request opportunities received during the respective time period, the target budget for the designated time period depending on the plurality of success probabilities.

9. The method recited in claim 1, wherein determining a pacing rate for the designated time period comprises estimating a win ratio for the designated time period, the estimated win ratio indicating a ratio of a first win rate for the designated time period and a second win rate for a preceding time period, the win rate for a time period indicating a probability that a bid placed on an advertising request opportunity received during the time period is successful.

10. The method recited in claim 1, wherein determining a pacing rate for the designated time period comprises estimating a request ratio for the designated time period, the estimated request ratio indicating a ratio of a first number of advertising request opportunities received during the designated time period and a second number of advertising request opportunities received during a preceding time period.

11. The method recited in claim 1, wherein each of the advertising request opportunities is capable of being purchased via an auction mechanism.

12. A system comprising:
a communications interface operable to receive a plurality of advertising request opportunities during a time interval, the time interval divided into a plurality of time periods, the plurality of time periods including a designated time period, each of the advertising request opportunities capable of being purchased to present a respective online advertisement;
a processor operable to determine a pacing rate for the designated time period, the pacing rate designating a portion of the advertising request opportunities received during the designated time period on which to bid; and
a storage medium operable to store one or more instructions to place a plurality of bids on selected ones of the advertising request opportunities received during the designated time period in accordance with the pacing rate.

13. The system recited in claim 12, wherein the processor is further configured to:
determine a target budget for the designated time period, wherein the pacing rate for the designated time period is determined based on the target budget for the designated time period.

14. The system recited in claim 13,
wherein determining the target budget comprises identifying an aggregate budget and an allocated budget expenditure, the aggregate budget identifying a first amount for spending during the time interval, the allocated budget expenditure identifying a second amount for spending during the designated time period, the target budget for the designated time period depending on the first amount and the second amount.

15. The system recited in claim 13,
wherein determining the target budget comprises identifying a first length of time associated with the time interval and a second length of time associated with the designated time period, the target budget for the designated time period depending on the first length of time and the second length of time.

16. The system recited in claim 13,
wherein the pacing rate for the designated time period is determined in accordance with a uniform pacing strategy, the uniform pacing strategy configured to provide an approximately uniform budget distribution across the plurality of time periods.

17. The system recited in claim 13,
wherein the pacing rate for the designated time period is determined in accordance with a weighted pacing strategy, the weighted pacing strategy configured to allocate relatively larger budget amounts to time periods during which received advertising request opportunities are expected to be associated with a relatively higher probability of success.

18. The system recited in claim 17,
wherein determining the target budget comprises identifying a plurality of success probabilities, each success probability being associated with a respective one of the plurality of time periods, each success probability indicating a relative quality of advertising request opportunities received during the respective time period, the target budget for the designated time period depending on the plurality of success probabilities.

19. One or more computer readable media having instructions stored thereon for performing a method, the method comprising:
receiving a plurality of advertising request opportunities during a time interval, the time interval divided into a plurality of time periods, the plurality of time periods including a designated time period, each of the advertising request opportunities capable of being purchased to present a respective online advertisement;
determining a pacing rate for the designated time period, the pacing rate designating a portion of the advertising request opportunities received during the designated time period on which to bid; and
transmitting one or more instructions to place a plurality of bids on selected ones of the advertising request opportunities received during the designated time period in accordance with the pacing rate.

20. The one or more computer readable media recited in claim 19, the method further comprising:
determining a target budget for the designated time period, wherein the pacing rate for the designated time period is determined based on the target budget for the designated time period.
